(19) United States
(12) Patent Application Publication
(10) Pub. No.: US 2011/0055642 A1
(43) Pub. Date: Mar. 3, 2011

(54) ARTICLE INFORMATION MANAGEMENT APPARATUS AND ARTICLE INFORMATION MANAGEMENT METHOD

(75) Inventor: Tatsuya KANEKO, Shizuoka (JP)

(73) Assignee: TOSHIBA TEC KABUSHIKI KAISHA, Tokyo (JP)

(21) Appl. No.: 12/869,042

(22) Filed: Aug. 26, 2010

(30) Foreign Application Priority Data
Aug. 31, 2009 (JP) 2009-200285

(51) Int. Cl. G06F 11/07

(52) U.S. Cl. 714/57; 714/E11.024

(57) ABSTRACT

A storage unit which stores table data defining information about each article sold in a store, a receiving unit which receives update data for the table data sent from an external device at a predetermined transmission time, a determination unit which determines whether the update data is received by the receiving unit or not during a lapse of a predetermined time from the transmission time, and a notification unit which notifies that the update data fails to arrive, when the determination unit determines that the update data is not received, are provided.

### CROSS-REFERENCE TO RELATED APPLICATION

This application is based upon and claims the benefit of priority from Japanese Patent Application No. 2009-200285 filed on Aug. 31, 2009, the entire contents of which are incorporated herein by reference.

### FIELD

Embodiments described herein relate generally to an article information management apparatus and an article information management method for managing an article master table.

### BACKGROUND

Conventionally, in a retail store such as a supermarket, article management and sales management are carried out using a POS (point of sales) system. In each store where the POS system is introduced, a store computer to manage an article master table that defines unit prices or the like of articles is provided and articles are sold on the basis of the unit prices registered in this article master table. Since the unit prices registered in the article master table vary daily, the store computer updates the article master table on the basis of update data that is sent from a higher-order host computer every predetermined time period (for example, every 24 hours).

There is also a system that enables free setting of unit prices of articles on the store side on the basis of the article master table. For example, JP-A-2008-71225 discloses a technique of providing a range of change limit amount and thus enabling prevention of setting errors on the store side.

However, in order to confirm whether update data arrives at the store computer or not, a worker needs to refer to communication history with the host computer each time. Therefore, there is a problem that the operation is troublesome.

Moreover, when a person in charge of the work in the store is not familiar with the operation, there is a possibility that the person cannot grasp non-arrival (arrival failure) of update data. The technique disclosed in JP-A-2008-71225 cannot detect arrival failure of unit price update information and therefore cannot solve the above problem.

### BRIEF DESCRIPTION OF THE DRAWINGS

FIG. 1 is a block diagram schematically showing a POS system.

FIG. 2 is a block diagram showing an exemplary configuration of an electrical system of a store computer shown in FIG. 1.

FIG. 3 shows exemplary data items that constitute an article master table shown in FIG. 2.

FIG. 4 shows exemplary data items that constitute a schedule table shown in FIG. 2.

FIG. 5 shows exemplary data items that constitute a store sales table shown in FIG. 2.

FIG. 6 is a flowchart showing a procedure for unit price update.

FIG. 7 is a flowchart showing another exemplary procedure for unit price update.

### DETAILED DESCRIPTION

According to an embodiment, an article information management apparatus includes: a storage unit which stores table data defining information about each article sold in a store; a receiving unit which receives update data for the table data sent from an external device at a predetermined transmission time; a determination unit which determines whether the update data is received by the receiving unit or not during a lapse of a predetermined time from the transmission time; and a notification unit which notifies that the update data fails to arrive, when the determination unit determines that the update data is not received.

According to another embodiment, an article information management method is executed by an article information management apparatus having a storage unit which stores table data defining information about each article sold in a store. The method includes: receiving, by a receiving unit, update data for the table data sent from an external device at a predetermined transmission time; determining, by a determination unit, whether the update data is received by the receiving unit or not during a lapse of a predetermined time from the transmission time; and notifying, by a notification unit, that the update data fails to arrive, when it is determined that the update data is not received.

Hereinafter, an embodiment of the article information management apparatus and the article information management method will be described in detail with reference to the attached drawings. The invention is not limited by the following description of the embodiment.

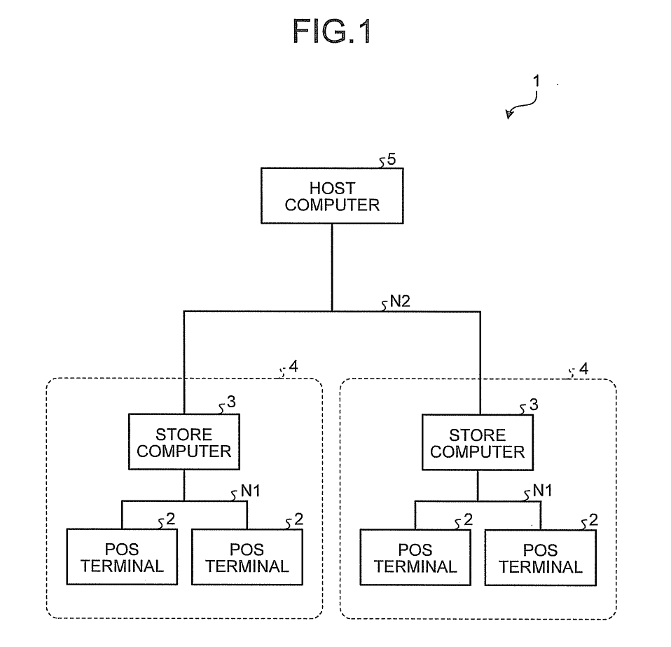

FIG. 1 is a block diagram schematically showing a POS system 1. As shown in FIG. 1, the POS system 1 has an in-store system 4 and a host computer 5. The in-store system 4 has one or plural POS terminals 2 and one store computer 3 which are installed within a store such as a supermarket. These devices are connected by a network N1 such as LAN. The store computer 3 in each in-store system 4 is connected to the host computer 5 via a network N2 such as LAN.

The POS terminal 2 is a terminal which is arranged at a checkout site or the like in the store and allows a cashier to carry out sales registration of articles. Specifically, in sales processing to carry out checkout of articles, the POS terminal 2 scans a barcode attached to each article by using a code scanner, not shown, and decodes the barcode to acquire article information including an article code, which will be described later. The POS terminal 2 also searches an article master table 381, which will be described later, stored in the store computer 3 on the basis of the acquired article information, thus acquires an article unit price, an article name or the like of the corresponding article, and generates sales data based on the article code, the number of items sold, the article name, the selling price and the like. Then, the POS terminal 2 calculates total amount of sales every time the article information is acquired, and repeats this operation until a current total key is pressed. When the current total key is pressed, the POS terminal 2 registers the generated sales data on a store sales table 383, which will be described later, in the store computer 3, and displays a calculated amount of change on a display device, not shown.

The store computer 3 is an article information management apparatus which manages information of the unit price and the like of articles sold in the store and also manages sales data registered from the POS terminal 2 in the store.

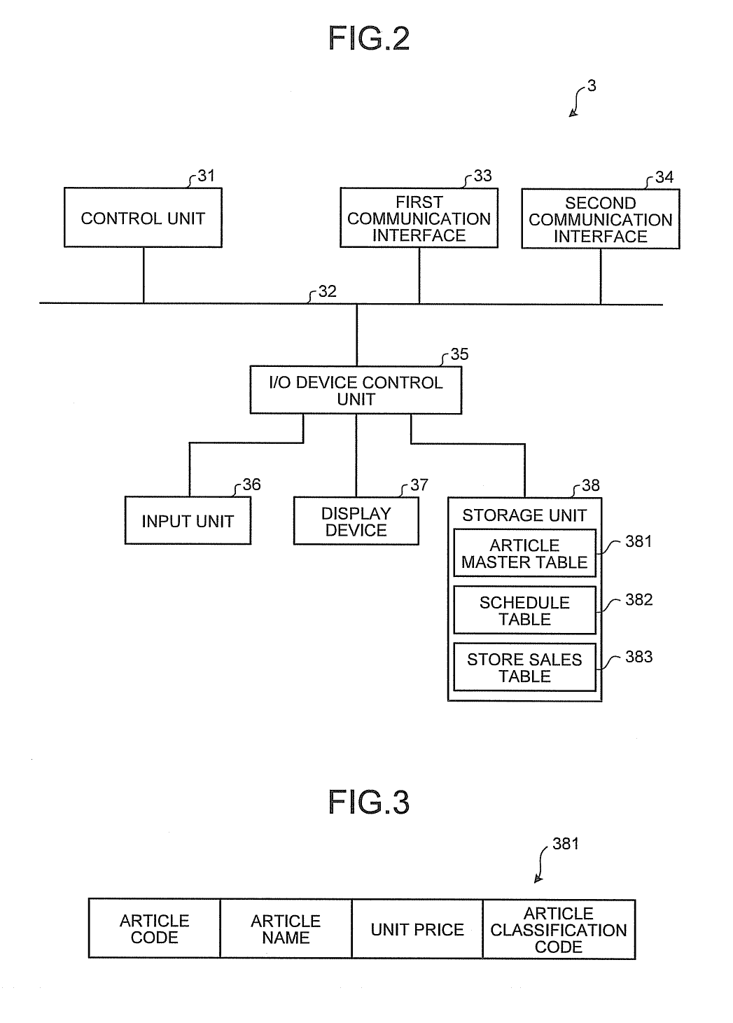

FIG. 2 is a block diagram showing an exemplary configuration of an electrical system of the store computer 3. As shown in FIG. 2, the store computer 3 has a control unit 31 including a CPU (central processing unit), a ROM (read only memory), a RAM (random access memory) or the like, not shown. The control unit 31 is configured in such a manner that the control unit 31 can communicate with the POS terminal 2 via a first communication interface 33 connected to a bus 32. The control unit 31 is also configured in such a manner that the control unit 31 can communicate with the host computer 5 via a second communication interface 34 connected to the bus 32.

An input unit 36, a display device 37 and a storage unit 38 are connected to the control unit 31 via the bus 32 and an I/O device control unit 35. The input unit 36 is an input device such as a keyboard or mouse. The display device 37 is a display device such as a liquid crystal display. The storage unit 38 is a storage device such as an HDD (hard disk drive) or SDD (solid state drive).

The storage unit 38 stores the article master table 381, a schedule table 382, the store sales table 383 and the like, in addition to various control programs executed by the CPU of the control unit 31.

FIG. 3 shows exemplary data items that constitute the article master table 381. As shown in FIG. 3, the article master table 381 is constituted by a record including data items such as article code, article name, unit price (selling price), and article classification code. Here, the “article code” is a unique code that is preset for each article in order to identify each article item sold in the store. The “article name”, “unit price” and “article classification code” are information about the article specified by the same article code.

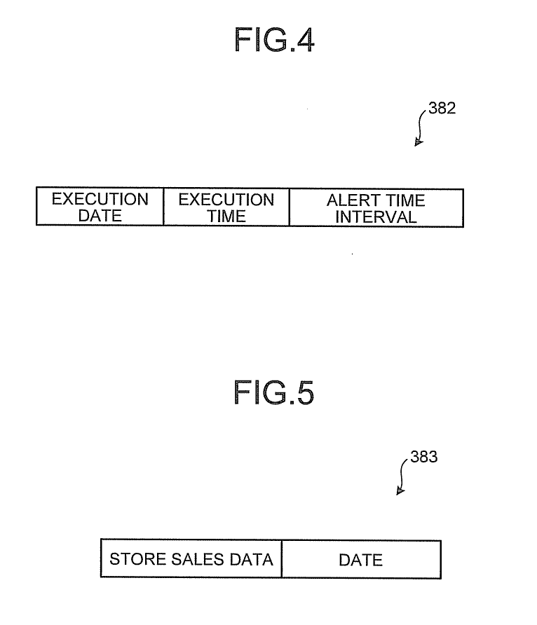

The schedule table 382 is a table to store setting information with respect to the execution of unit price update, which will be described later. Here, FIG. 4 shows exemplary data items that constitute the schedule table 382. As shown in FIG. 4, the schedule table 382 is constituted by a record including data items such as execution date, execution time, and alert time interval.

Here, the “execution date” and “execution time” are data items for setting the date and time to execute the unit price update, which will be described later. The control unit 31 starts the unit price update, which will be described later, according to the date and time set as the “execution date” and “execution time”. The date set as the “execution date” is not particularly specified. However, it is preferable that the date corresponds to a business day of the store.

As the “execution time”, time corresponding to the time (transmission time) when a unit price update file is sent from the host computer 5 is set. For example, where the transmission time for the unit price update file is set to 7:00 a.m., the same time as this transmission time may be set as the “execution time” or time preceding the transmission time (for example, 6:50 a.m.) may be set as the “execution time”.

A day of the week may be set as the “execution date”. In such case, the control unit 31 starts the unit price update at the “execution time” on the day of the week that is set as the “execution date”.

The “alert time interval” is a data item for setting a time interval at which absence of transmission of the unit price update file from the host computer 5 is notified of, where such absence occurs. Specifically, the control unit 31 waits for reception of the unit price update file from the time set as the “execution time”, and causes the display device 37 to display a screen showing arrival failure of the unit price update file where the unit price update file cannot be received before the lapse of the time set as the “alert time interval” (for example, 30 minutes) from the time set as the “execution time”.

FIG. 5 shows exemplary data items that constitute the store sales table 383. As shown in FIG. 5, the store sales table 383 is constituted by a record including a data item (store sales data) in which store sales data acquired by totaling sales data sent from each POS terminal 2 within the store is stored and a data item (date) indicating the date when this totaling is carried out. The control unit 31 sends the record stored in the store sales table 383 as sales information to the host computer 5 in prescribed timing.

The host computer 5 communicates with each store computer 3 via the network N2 and centrally controls each in-store system 4. Specifically, the host computer 5 sends the unit price update file to each store computer 3 in accordance with a predetermined schedule and thereby updates unit prices of articles stored in the article master table 381 in each store computer 3. In the unit price update file, article codes of articles as subjects of update and the unit prices of the articles are defined in association with each other.

The host computer 5 has a storage device (not shown) which stores a general sales table having the same data configuration as the above store sales table 383. Every time store sales data is sent from each store computer 3, the host computer 5 registers the store sale data on the general sales table. Alternatively, information to identify each in-store system 4 (store computer 3) may be registered in association with store sales data.

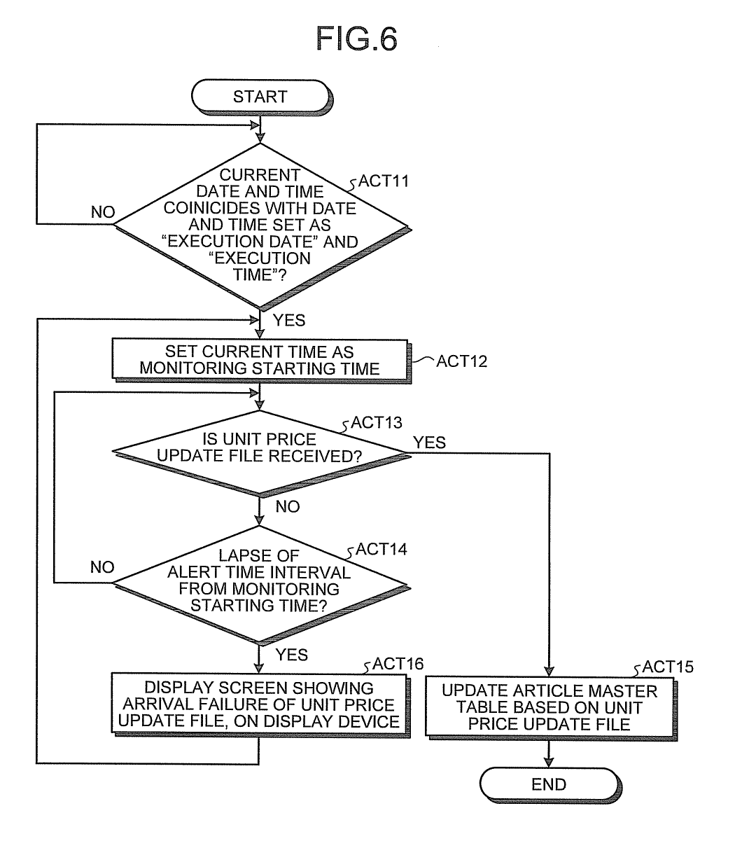

Hereinafter, the unit price update executed by the control unit 31 of the store computer 3 will be described with reference to FIG. 6. Here, FIG. 6 is a flowchart showing the procedure of the unit price update realized by the cooperation between the CPU of the control unit 31 and the control program stored in the storage unit 38.

First, the control unit 31 waits until the current date and time coincides with the date and time set as the “execution date” and “execution time” on the schedule table 382 (No in ACT 11). The current date and time is acquired by the control unit 31 from a timer device, not shown, such as RTC (real time clock).

When the current date and time coincides with the date and time set as the “execution date” and “execution time” on the schedule table 382 in ACT 11 (Yes in Act 11), the control unit 31 sets this current time as a monitoring starting time (ACT 12).

Subsequently, the control unit 31 monitors a signal inputted to the second communication interface 34 and determines whether a unit price update file is received from the host computer 5 or not (ACT 13). Here, when it is determined that the unit price update file is not received (No in ACT 13), the control unit 31 determines whether there is the lapse of the time set as the “alert time interval” on the schedule table 382 (for example, 30 minutes) from the monitoring starting time or not (ACT 14). Here, when it is determined that there is not the lapse of the alert time interval from the monitoring starting time (No in ACT 14), the control unit 31 returns to ACT 13. That is, the control unit 31 waits for reception of the unit price update file during the time period set as the “alert time interval” from the monitoring starting time.

When the unit price update file is sent from the host computer 5 during this waiting period (No in ACT 13->No in ACT 14), the control unit 31 determines that the unit price update file is received (Yes in ACT 13). Then, on the basis of the article code and unit price included in the unit price update file, the control unit 31 updates the unit price corresponding to the article code in question stored in the article master table 381 (ACT 15) and ends this processing.

Meanwhile, when the waiting period passes while no unit price update file is received (Yes in ACT 14), the control unit 31 causes the display device 37 to display a screen showing arrival failure of the unit price update file and thus notifies the operator operating the store computer 3 of the arrival failure of the unit price update file (ACT 16).

Subsequently, the control unit 31 returns to ACT 12, thus sets the current time as a new monitoring starting time, and waits for the reception of the unit price update file during the alert time interval from this monitoring starting time.

As described above, the store computer 3 according to this embodiment monitors the reception of the unit price update file sent from the host computer 5 at a predetermined time, and when the unit price update file cannot be received during the lapse of a predetermined time period from the predetermined time, the store computer 3 notifies that the unit price update file fails to arrive. Therefore, non-arrival (arrival failure) of update data sent from an external device can be securely detected and notified of. Moreover, since a notification is given every predetermined time period until the unit price update file is received, arrival failure of the unit price update file can be notified of more securely.

While the embodiment of the invention is described above, the invention is not limited to the embodiment. Various changes, replacements, additions and the like can be made without departing from the scope of the invention.

For example, in the embodiment, when the unit price update file fails to arrive, a message indicating the arrival failure is displayed on the display device 37 of the store computer 3 and the arrival failure is thus notified of. However, the notification method is not limited to the method described in the embodiment.

As another notification method, for example, a message notifying of arrival failure (non-arrival) of update data may be sent to the host computer 5 serving as the transmission source of the unit price update file, via the second communication interface 34.

Alternatively, the e-mail address of the manager of the host computer 5 or the manager of the store computer 3 or the like may be stored in advance in the storage unit 38 or the like, and in the case of arrival failure of the unit price update file, an e-mail notifying of the arrival failure of the unit price update file may be sent to this e-mail address via the first communication interface 33 or the second communication interface 34.

Also, an alert sound or the like may be outputted from an audio output device, not shown, to notify of arrival failure of update data.

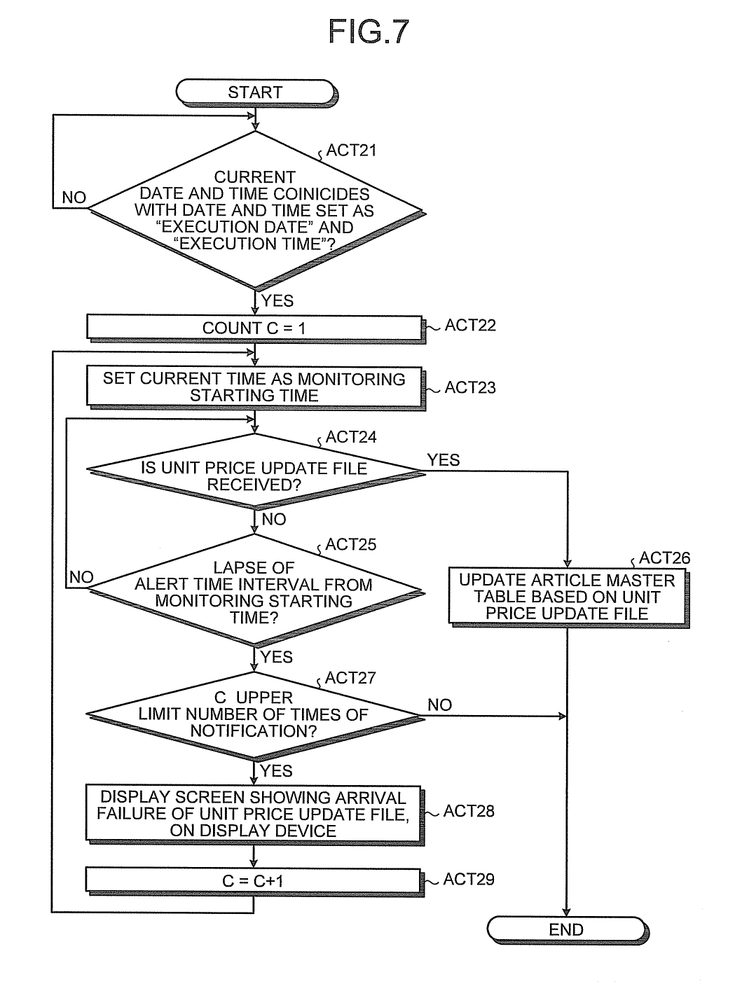

In the above embodiment, the notification of arrival failure is repeated every time period set as the “alert time interval” until the unit price update file is received. However, without being limited to the embodiment, the number of times the notification is given (hereinafter referred to as the upper limit number of times of notification) may be set. Hereinafter, the operation of the store computer 3 in such case will be described with reference to FIG. 7.

FIG. 7 is a flowchart showing another exemplary procedure of unit price update realized by the cooperation between the CPU of the control unit 31 and the control program stored in the storage unit 38. In this processing, it is assumed that the upper limit number of times of notification (for example, 3 times) is preset in the schedule table 382 in the storage unit 38 or another storage area.

First, the control unit 31 waits until the current date and time coincides with the date and time set as the “execution date” and “execution time” on the schedule table 382 (No in ACT 21). The current date and time is acquired by the control unit 31 from a timer device, not shown, such as RTC (real time clock).

When the current date and time coincides with the date and time set as the “execution date” and “execution time” on the schedule table 382 in ACT 21 (Yes in Act 21), the control unit 31 initializes a counter C for counting the number of times of notification to “1” (ACT 22). Then, the control unit 31 sets the current time as a monitoring starting time (ACT 23).

Subsequently, the control unit 31 monitors a signal inputted to the second communication interface 34 and determines whether the unit price update file is received from the host computer 5 or not (ACT 24). Here, when it is determined that the unit price update file is not received (No in ACT 24), the control unit 31 determines whether there is the lapse of the time set as the “alert time interval” on the schedule table 382 (for example, 30 minutes) from the monitoring starting time or not (ACT 25). Here, when it is determined that there is not the lapse of the alert time interval from the monitoring starting time (No in ACT 25), the control unit 31 returns to ACT 24. That is, the control unit 31 waits for the reception of the unit price update file during the time period set as the “alert time interval” from the monitoring starting time.

When the unit price update file is sent from the host computer 5 during this waiting period (No in ACT 24->No in ACT 25), the control unit 31 determines that the unit price update file is received (Yes in ACT 24). Then, on the basis of the article code and unit price included in the unit price update file, the control unit 31 updates the unit price corresponding to the article code in question stored in the article master table 381 (ACT 26) and ends this processing.

Meanwhile, when the waiting period passes while no unit price update file is received (Yes in ACT 25), the control unit 31 determines whether the current value of the counter C is equal to or lower than the upper limit number of times of notification (ACT 27). Here, when the value of the counter C exceeds the upper limit number of times of notification (No in ACT 27), this processing ends.

Meanwhile, when it is determined that the value of the counter C is equal to or lower than the upper limit number of times of notification in ACT 27 (Yes in ACT 27), the control unit 31 causes the display device 37 to display a screen showing arrival failure of the unit price update file and thus notifies the operator operating the store computer 3 of the arrival failure of the unit price update file (ACT 28).

Then, the control unit 31 increments the value of the counter C by 1 (ACT 29) and returns to ACT 23. With such a configuration, the number of times a notification is given at the time of arrival failure of the unit price update file can be limited to the upper limit number of times of notification. Therefore, convenience to the user can be realized.

Also, while the case of updating the unit price of an article included in the record that is registered in the article master table is described in the above embodiment, the invention may be applied to the case of updating other information about an article such as bargain sale data to specifying a bargain sale article.

Moreover, while the example of applying the invention to the store computer 3 is described in the above embodiment, the application of the invention is not limited to this embodiment. The invention can be applied to any device which updates information about an article in accordance with update data sent from an external device at a predetermined time.

While certain embodiments have been described, these embodiments have been presented by way of example only, and are not intended to limit the scope of the inventions. Indeed, the novel methods and systems described herein may be embodied in a variety of other forms: furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An article information management apparatus comprising:
a storage unit which stores table data defining information about each article sold in a store;
a receiving unit which receives update data for the table data sent from an external device at a predetermined transmission time;
a determination unit which determines whether the update data is received by the receiving unit or not during a lapse of a predetermined time from the transmission time; and
a notification unit which notifies that the update data fails to arrive, when the determination unit determines that the update data is not received.

2. The apparatus of claim 1, wherein the determination unit sets a monitoring starting time according to the transmission time, and determines whether the update data is received by the receiving unit or not, during a lapse of a predetermined time from the monitoring starting time.

3. The apparatus of claim 2, wherein the monitoring starting time is the same time as the transmission time or a time preceding the transmission time.

4. The apparatus of claim 2, wherein when it is determined that the update data is not received during the lapse of the predetermined time from the monitoring starting time, the determination unit resets a time when the lapse of the predetermined time ends, as the monitoring starting time, and
the notification unit notifies of arrival failure of the update data every time the determination unit determines that the update data is not received.

5. The apparatus of claim 4, wherein the notification unit notifies of the arrival failure of the update data every time the determination unit determines that the update data is not received, until a predetermined upper limit number of times of notification is reached.

6. The apparatus of claim 1, wherein the notification unit causes a display device to display a message showing arrival failure of the update data.

7. The apparatus of claim 1, wherein the notification unit notifies the external device of arrival failure of the update data.

8. The apparatus of claim 1, wherein the notification unit sends an e-mail notifying of arrival failure of the update data to a predetermined e-mail address.

9. The apparatus of claim 1, wherein the table data is an article master table which manages a selling price of the each article, and the update data is to update the selling price of a specific article or all articles registered in the article master table.

10. An article information management method executed by an article information management apparatus having a storage unit which stores table data defining information about each article sold in a store, the method comprising:
receiving, by a receiving unit, update data for the table data sent from an external device at a predetermined transmission time;
determining, by a determination unit, whether the update data is received by the receiving unit or not during a lapse of a predetermined time from the transmission time; and
notifying, by a notification unit, that the update data fails to arrive, when it is determined that the update data is not received.
